(19) United States
(12) Patent Application Publication
(10) Pub. No.: US 2017/0003928 A1
(43) Pub. Date: Jan. 5, 2017

(54) CONTENT PLAYBACK DEVICE

(71) Applicant: YG Creative Inc., Brooklyn, NY (US)

(72) Inventor: Yehieda Goldberger, Brooklyn, NY (US)

(21) Appl. No.: 15/199,966

(22) Filed: Jun. 30, 2016

Related U.S. Application Data
(60) Provisional application No. 62/187,795, filed on Jul. 1, 2015.

(51) Int. Cl. G06F 3/16; G06F 3/02

(52) U.S. Cl. CPC G06F 3/162; G06F 3/165; G06F 3/02

(57) ABSTRACT

Content playback devices are presented including: a processor; an input component for receiving content and for receiving configuration instructions; an output component for outputting content; a user interface component having a physical user interface, where the physical user interface includes, a number of player control buttons, and a number of content mapped playback buttons; an internal content component for providing content from a removable media; and a data storage component for storing at least loaded content. In some embodiments, each of the number of content mapped playback buttons further include: an insert sleeve for receiving an insert identifying content mapped to the content mapped playback button.

### PRIORITY CLAIM TO PROVISIONAL APPLICATION

A claim for priority is hereby made under the provisions of 35 U.S.C. §119 for the present application based upon U.S. Provisional Application No. 62/187,795 filed on Jul. 1, 2015 which is incorporated herein by reference.

### BACKGROUND

Portable MP3 media players commonly available store audio digitally via non-volatile memory, which means that the device can retrieve stored information even after having been powered off and on. While conventional players are generally simple to use, younger children and older adults may experience difficulties using these players. For example, the digital structure/layout may be difficult for children to browse an existing audio album collection while older adults may be unfamiliar with a particular user interface used for browsing. In addition, many conventional media players are not available with built-in speakers and must to be connected to an output source such as speakers or headphones. Still further, conventional portable MP3 Media Player devices are often too small and fragile for young children's use or may be difficult to manipulate for older adults.

CD players provide an even simpler interface, but suffer from the fact that a physical CD must be placed in the player each time a user wishes to change music. Thus, in order to have access to a large collection, storage and transportation of media may become an issue. As such, content playback devices are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, content playback devices are presented including: a processor; an input component for receiving content and for receiving configuration instructions; an output component for outputting content; a user interface component having a physical user interface, where the physical user interface includes, a number of player control buttons, and a number of content mapped playback buttons; an internal content component for providing content from a removable media; and a data storage component for storing at least loaded content. In some embodiments, each of the number of content mapped playback buttons further include: an insert sleeve for receiving an insert identifying content mapped to the content mapped playback button. In some embodiments, each of the content mapped playback buttons further include: an illumination element to indicate when content corresponding with the content mapped playback button is playing. In some embodiments, each of the content mapped playback buttons correspond with content selected from the group consisting of: an audio file, a visual file, an audio/visual file, a collection of audio files, a collection of visual files, and a collection of audio/visual files. In some embodiments, the input component is capable of receiving input from any selected from the group consisting of: the internal content component, a microphone, an external CD drive, an external hard drive, a solid state drive, a cloud drive, a computing device, a networked computing device, and a second content playback device. In some embodiments, the user interface component further includes: a display for providing a graphical user interface for the content playback device. In some embodiments, the player control buttons are selected from the group consisting of: a stop button, a play button, a pause button, a combination play/pause button, a forward button, a back button, a fast forward button, a fast backward button, a next button, a previous button, a combination forward/next button, a combination forward/fast forward/next button, a combination backward/previous button, a combination backward/fast backward/previous button, a record button, a load button, a transfer button, an input source button, a player select button, a volume button, and an arrow button. In some embodiments, the output component further includes an output element selected from the group consisting of: an audio jack, a video jack, an audio/video jack, a digital output jack, a wireless output element, and a speaker.

In other embodiments methods of utilizing a content playback device are presented including: providing the content playback device, where the content playback device includes, a processor, an input component for receiving content and for receiving configuration instructions, an output component for outputting content, a physical user interface including, a number of player control buttons, and a number of content mapped playback buttons; an internal content component for providing content from a removable media, and a data storage component for storing at least loaded content; electronically connecting an input source with the content playback device; if the input source includes stored content, selecting at least a portion of the stored content for storing to the content playback device; mapping at least one of the number of content mapped playback buttons to correspond with the selected portion; loading the selected portion of stored content to the content playback device. In some embodiments, methods further include: if the input source does not include stored content, providing a live source for live source content; mapping at least one of the number of content mapped playback buttons to correspond with the live source content; and loading the live source content to the content playback device. In some embodiments, methods further include: selecting one of the number of content mapped playback buttons; and playing back loaded content corresponding with the content mapped playback button.

In other embodiments, systems for providing simplified playback of content are presented including: a content playback device, where the content playback device includes, a processor, an input component for receiving content and for receiving configuration instructions, an output component for outputting content, a physical user interface including, a number of player control buttons, and a number of content mapped playback buttons; an internal content component for providing content from a removable media, and a data storage component for storing loaded content; an external content storage for providing stored content; and an external user interface coupled with a computing device for remotely configuring the content playback device. In some embodiments, the computing device is coupled with a network capable of receiving stored content from a network connected storage.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a system for providing simplified playback of content a content playback device in accordance with embodiments of the present invention;

FIG. 2 is an illustrative representation of a content playback device in accordance with embodiments of the present invention;

FIG. 3 is an illustrative flowchart of methods for loading content on a content playback device in accordance with embodiments of the present invention; and

FIG. 4 is an illustrative flowchart of methods for playing loaded content on a content playback device in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

As utilized herein, the term “stored content” refers to content that may be loaded to a content playback device embodiment. In contrast, the term “loaded content” refers to content loaded to a content playback device embodiment.

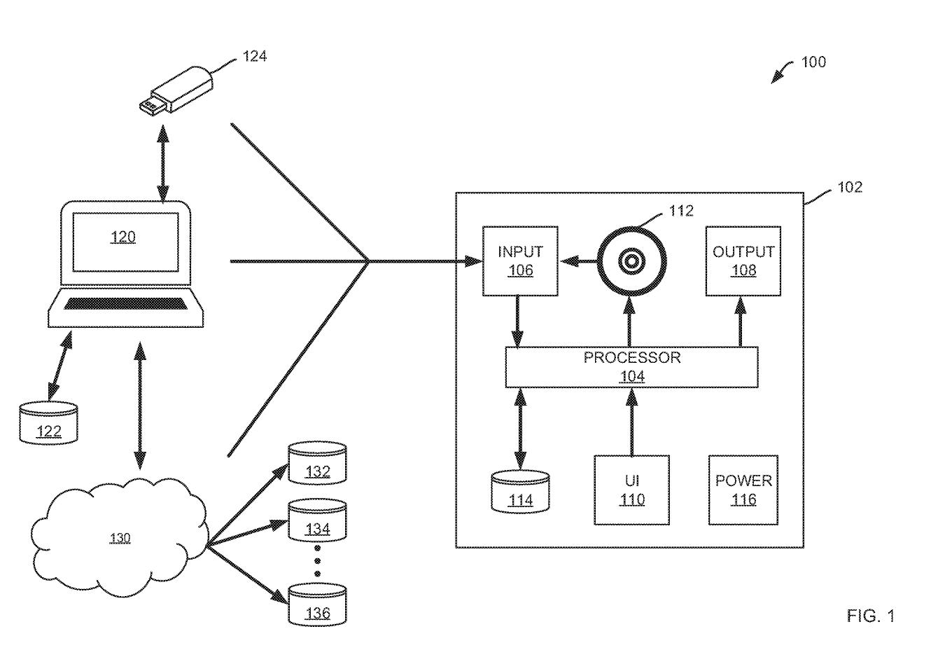

FIG. 1 is an illustrative representation of a system 100 for providing simplified playback of content on a content playback device 102 in accordance with embodiments of the present invention. As illustrated, content playback device 102 may include several components. For example, specialized or general purpose processor 104 may be utilized to perform programmatic tasks. Processor 104 may be electronically coupled with input component 106, which component may be utilized for receiving content and for receiving configuration instructions. In embodiments, content may be received from a variety of sources and may include stored content or live content. Stored content, in embodiments, may be received from any number of both internal and external sources without limitation. As an illustrative example embodiment, stored content may be received from internal content component 112 having removable media such as a CD, a DVD, or any other removable media. As another illustrative example embodiment, stored content may be received from an external device such as: computing device 120 having storage 122; solid state device 124; cloud drives 132, 134, and 136 accessible via computerized network 130. In addition, other embodiments may include: an external hard drive, an external CD drive, an external DVD drive, and another content playback device as disclosed herein and without limitation. Input component may further receive live content from a microphone, an external media player, or from internal content component in embodiments. As illustrated, processor 104 may be further electronically coupled with data storage component 114 to store content received by playback device 102 as well as other programmatic instruction as required to enable the functions disclosed herein.

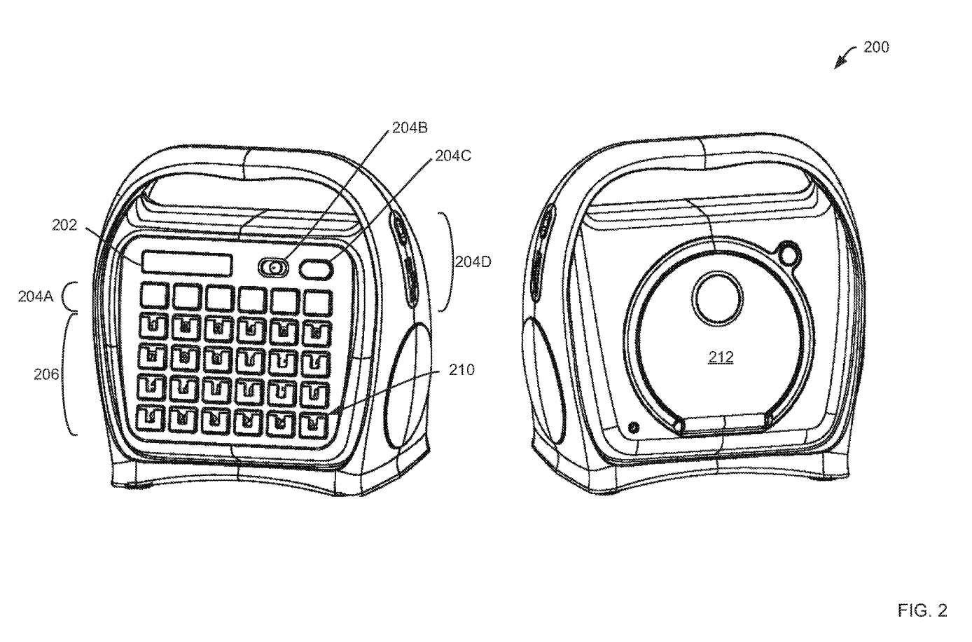

Further illustrated is output component 108 that may be electronically coupled with processor 104. In embodiments, output component provides output to any of a variety of output elements such as: an audio jack, a video jack, an audio/video jack, a digital output jack, a wireless output element, and a speaker without limitation. Still further illustrated is user interface component 110. User interface 110 may include a physical user interface and a graphical user interface. User interface embodiments will be discussed in further detail below for FIG. 2. It may be noted that the physical user interface, in particular, is intended to provide a simple way to access and playback stored content. Still further illustrated is power component 116. Any power supply known in the art may be utilized to provide power to content playback devices without departing from embodiments disclosed herein.

FIG. 2 is an illustrative representation of a content playback device 200 in accordance with embodiments of the present invention. In particular, FIG. 2 illustrates front and back orthogonal views of a content playback device embodiment. As illustrated, along one face, display 202 provides a graphical user interface for use during configuration and playback. Further illustrated are a number of player control buttons 204A, 204B, 204C, and 204D. In general, player control buttons control loading and playback of content playback device embodiments, powering the content playback device on and off, and controlling volume of the content playback device. In embodiments, player control buttons may each be configured in any manner including without limitation:

a stop button for stopping content when depressed, touched, or tapped;

a play button for playing content when depressed, touched, or tapped;

a pause button for pausing content when depressed, touched, or tapped;

a combination play/pause button for playing and pausing content when depressed, touched, or tapped;

a forward button for moving content forward a specified or default amount when depressed, touched, or tapped;

a back button for moving content backward a specified or default amount when depressed, touched, or tapped;

a fast forward button for moving content forward rapidly when depressed, touched, or tapped;

a fast backward button for moving content backward rapidly when depressed, touched, or tapped;

a next button for moving to a next portion of content when depressed, touched, or tapped;

a previous button for moving to a previous portion of content when depressed, touched, or tapped;

a combination forward/next button for moving content forward rapidly and for moving to a next portion of content when depressed, touched, or tapped;

a combination forward/fast forward/next button for moving content forward, for moving content forward rapidly, and for moving to a next portion of content when depressed, touched, or tapped;

a combination backward/previous button for moving content backward rapidly and for moving to a previous portion of content when depressed, touched, or tapped;

a combination backward/fast backward/previous button for moving content backward, for moving content backward rapidly backward, and for moving to a previous portion of content when depressed, touched, or tapped;

a record button for initiating recording of live source content from a live source when depressed, touched, or tapped;

a load button for loading stored content from a data store when depressed, touched, or tapped;

a transfer button for transferring stored content from a second content playback device when depressed, touched, or tapped;

a input source button for selecting an input source when depressed, touched, or tapped;

a player select button for selecting a source for playback when depressed, touched, or tapped;

a volume button for raising and lowering volume; and

a number of arrow buttons for navigating computerized files to find and select stored content when depressed, touched, or tapped.

In some embodiments, arrow button may be combined with other buttons such as with forward/fast forward/next buttons. It may be appreciated that combination buttons may have functions that are defined either by the current status or by multiply pressing the combination button. For example, with respect to a combination play/pause button, when content is not being played, then depressing the combination play/pause button will cause the content playback device to play content. Depressing the combination play/pause button during playback will cause the content playback device to pause content. Any number of combinations may be utilized without limitation and without departing from present embodiments. The provided descriptions is intended for illustrative purposes and should not be construed as limiting with respect to the number and kind of combinations available.

Further illustrated are any number of content mapped playback buttons 206. In general, content mapped playback buttons provide playback of a user specified content. For example, an audio file, a visual file, an audio/visual file, a collection of audio files, a collection of visual files, and a collection of audio/visual files may be mapped to a particular content mapped playback button. Content mapped playback button embodiments may include several functionalities including:

a map function for mapping content to a content mapped playback button when depressed, touched, or tapped during a load function;

a call function for initiating playback of mapped content when depressed, touched, or tapped; and

a next function for selecting a next song in an album that has been mapped to a content mapped playback button when depressed, touched, or tapped.

Any number of functions may be handled by content mapped playback buttons in embodiments. In addition, content mapped playback buttons may include an insert sleeve 210 for receiving an insert identifying content mapped to the content mapped playback button. In this manner, a simplified physical user interface may be presented to a user so that desired content may be easily and readily played. In some embodiments, a perforated sheet may be provided so that inserts may be printed with a conventional printer. In other embodiments, an insert die may be provided for cutting out appropriately sized inserts from printed material. In still other embodiments, content mapped playback buttons may further include an illumination element to indicate when content corresponding with the content mapped playback button is playing. In this manner, content being played may be readily and easily identified.

Embodiments may further include a number of input and output jacks, which are known in the art and may be positioned along any surface of the content playback device embodiments without limitation. Input and output jacks, in embodiments, may include: an audio jack, a video jack, an audio/video jack, and a digital jack without limitation. In some embodiments, as illustrated, content playback devices may include internal content component 212 such as a CD player or DVD player. As illustrated, internal content component 212 is positioned in a vertical orientation, however, in embodiments, internal content components may be positioned in any orientation without limitation.

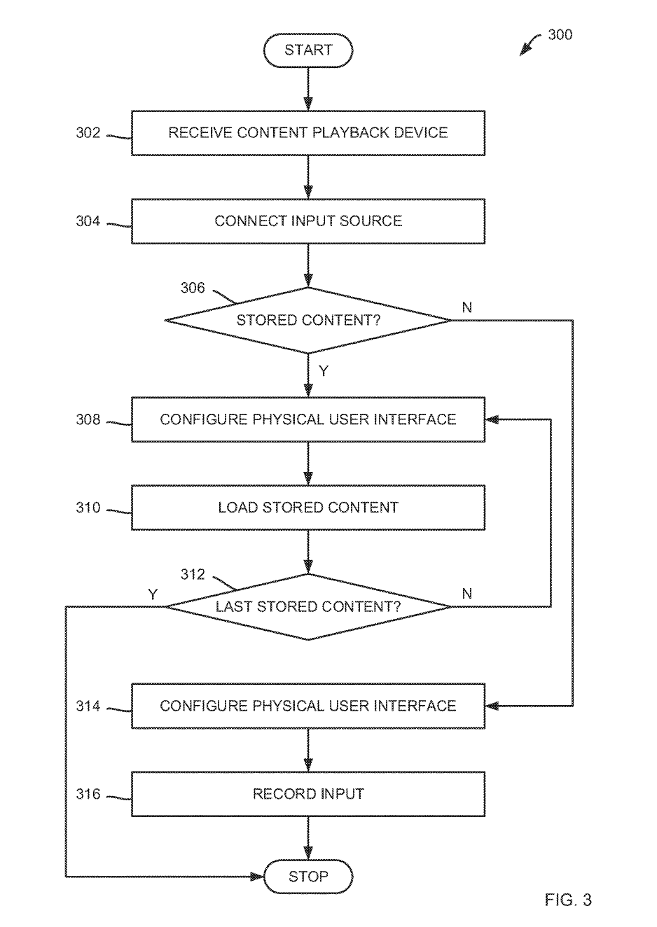

FIG. 3 is an illustrative flowchart 300 of methods for loading content on a content playback device in accordance with embodiments of the present invention. At a first step 302, the method receives a content playback device embodiment as disclosed herein. In some embodiments one or more content playback devices may be received and may be interconnected to share content or to configured substantially simultaneously with the same content. At a next step 304, the method connects or selects an input source. In embodiments, input sources may include without limitation: an internal content component, a microphone, an external CD drive, an external hard drive, a solid state drive, a cloud drive, a computing device, a networked computing device, or a second content playback device. At a next step 306, the method determines whether content is stored content. Content may include stored content that includes: an audio file, a visual file, an audio/visual file, a collection of audio files, a collection of visual files, and a collection of audio/visual files or may include live source content from a live source. As such, the method continues to a step 306 to determine whether content is stored content. If the method determines at a step 306 that the content is stored content, the method continues to a step 308 to configure the physical user interface. Configuring the user interface may include selecting some portion of stored content for storing to the content playback device and mapping a content mapped playback button to correspond with the selected portion of stored content. In some embodiments, mapping may be accomplished by depressing a desired content mapped playback button. In other embodiments, mapping may be accomplished through a graphical user interface on a display on the content playback device. In still other embodiments, mapping may be accomplished through a graphical user interface on a display on an external computing device. As such, the flexibility and ease of mapping may be selected to accommodate the needs of a particular user.

After configuring the physical user interface, the method continues to a step 310 to load the stored content to the content playback device. Content may be stored in any manner known in the art on any storage device without departing from embodiments disclosed herein. At a next step 312, the method determines whether the stored content is the last stored content to be stored on the content playback device. If the method determines at a step 312 that the stored content is the last stored content to be stored on the content playback device, the method ends. If the method determines at a step 312 that the stored content is not the last stored content to be stored on the content playback device, the method continues to a step 308 to configure the physical user interface.

Returning to a step 306, if the method determines that the content is not stored content, the method continues to a step 314 to configure the physical user interface to receive live content. Configuring the user interface may include selecting an input source, such as a connected external player, a microphone or the internal content component for receiving live source content by the content playback device and mapping a content mapped playback button to correspond with the live source content. In some embodiments, mapping may be accomplished by depressing a desired content mapped playback button. In other embodiments, mapping may be accomplished through a graphical user interface on a display on the content playback device. In still other embodiments, mapping may be accomplished through a graphical user interface on a display on an external computing device. As such, the flexibility and ease of mapping may be selected to the needs of a particular user. After configuring the physical user interface, the method continues to a step 316 to record the live source content from a live source to the content playback device whereupon the method ends. Content may be stored in any manner known in the art on any storage device without departing from embodiments disclosed herein.

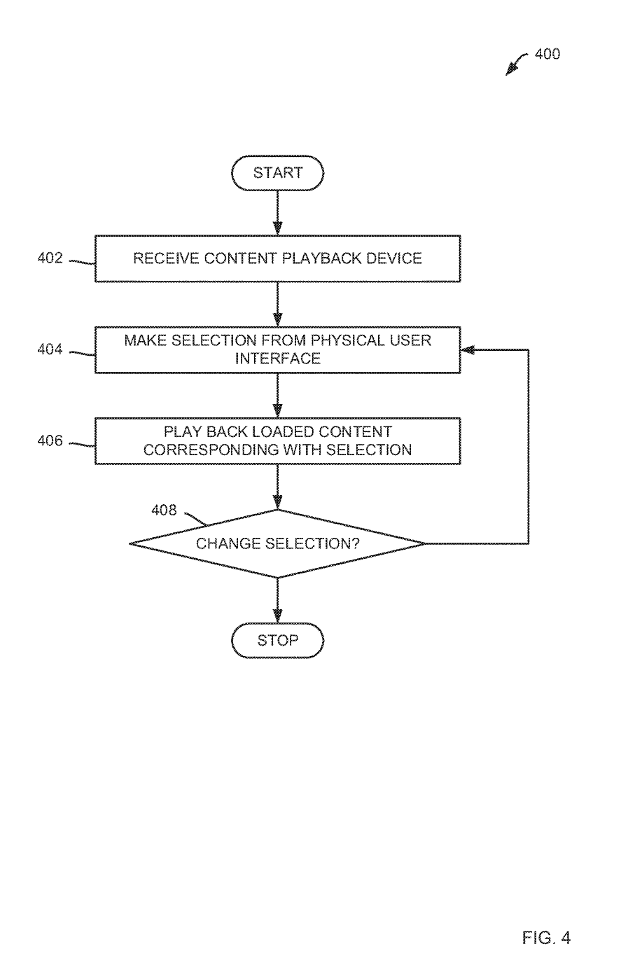

FIG. 4 is an illustrative flowchart 400 of methods for playing content on a content playback device in accordance with embodiments of the present invention. At a first step 402, the method receives a content playback device embodiment as disclosed herein. At a next step 404, the method makes a selection from the physical user interface. In operation, a content mapped playback button may be depressed to select content mapped to the button. Thus, a user need not scroll through menus to select content, but may simply depress a button to quickly and easily select content. In embodiments, content may be visually identified on the physical user interface button by an insert identifying content that has been inserted into an insert sleeve on the button. In some embodiments, when a user depresses a content mapped playback button, the button may be illuminated to indicate that the button is active. At a next step 406, the method plays back content corresponding with the user selection. During content, in embodiments, the user may select a player control button to control playback. Player control buttons may include: a stop button, a play button, a pause button, a combination play/pause button, a forward button, a back button, a fast forward button, a fast backward button, a next button, a previous button, a combination forward/next button, a combination forward/fast forward/next button, a combination backward/previous button, a combination backward/fast backward/previous button, a record button, a load button, a transfer button, an input source button, a player select button, a volume button, and an arrow button without limitation. Furthermore, during playback, a user may provide live source content to “sing along” with content being played back. In some embodiments, the content playback device may be configured to record live source content along with content being played back to create new storable content.

At a next step 408, the method determines whether to change selection. If the method determines at a step 408 to change selection, the method continues to a step 404 to make a selection from the physical user interface. In some embodiments, selecting the same content mapped playback button that is currently selected simply moves to a next content file associated with the button as, for example, when an album is mapped to a particular content mapped playback button. If the method determines at a step 408 not to change selection, the method ends.

### ALTERNATE EMBODIMENTS

In some alternate embodiments, content playback devices may be utilized to control and playback external connected devices. For example, an external CD player having one or more CDs may be electronically coupled with content playback device embodiments. Content mapped playback buttons may be configured to access media stored on the external CD player and player control buttons may then be utilized to control playback of the external CD player. In this manner, a user may store media in a centralized location and allow access to media by a user utilizing a content playback device embodiment as disclosed herein. Any type of external media device or storage may be controlled in this manner without departing from embodiments provided herein.

In other embodiments, content playback devices may be utilized in coordination with an external media play device. For example, a portable MP3 media player may be electronically coupled with a content playback device embodiment for playing back content stored on the portable MP3 media player. Media players may be selected for playback by utilizing a player select button as disclosed above. Any selected output on the content playback device may be utilized to provide output for the portable MP3 media player. In addition, any external media play device known in the art may be utilized in this manner without departing from embodiments provided herein.

The terms “certain embodiments”, “an embodiment”, “embodiment”, “embodiments”, the embodiment“, the embodiments”, one or more embodiments“, some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A content playback device comprising:
a processor;
an input component for receiving content and for receiving configuration instructions;
an output component for outputting content;
a user interface component having a physical user interface, wherein the physical user interface includes,
a plurality of player control buttons,
and a plurality of content mapped playback buttons;
an internal content component for providing content from a removable media; and
a data storage component for storing at least loaded content.

2. The content playback device of claim 1, wherein each of the plurality of content mapped playback buttons further comprise:
an insert sleeve for receiving an insert identifying content mapped to the content mapped playback button.

3. The content playback device of claim 1, wherein each of the plurality of content mapped playback buttons further comprise:
an illumination element to indicate when content corresponding with the content mapped playback button is playing.

4. The content playback device of claim 1, wherein each of the plurality of content mapped playback buttons correspond with content selected from the group consisting of: an audio file, a visual file, an audio/visual file, a collection of audio files, a collection of visual files, and a collection of audio/visual files.

5. The content playback device of claim 1, wherein the input component is capable of receiving input from any selected from the group consisting of: the internal content component, a microphone, an external CD drive, an external hard drive, a solid state drive, a cloud drive, a computing device, a networked computing device, and a second content playback device.

6. The content playback device of claim 1, wherein the user interface component further comprises:
a display for providing a graphical user interface for the content playback device.

7. The content playback device of claim 1, wherein the plurality of player control buttons are selected from the group consisting of: a stop button, a play button, a pause button, a combination play/pause button, a forward button, a back button, a fast forward button, a fast backward button, a next button, a previous button, a combination forward/next button, a combination forward/fast forward/next button, a combination backward/previous button, a combination backward/fast backward/previous button, a record button, a load button, a transfer button, an input source button, a player select button, a volume button, and an arrow button.

8. The content playback device of claim 1, wherein the output component further comprises an output element selected from the group consisting of: an audio jack, a video jack, an audio/video jack, a digital output jack, a wireless output element, and a speaker.

9. A method of utilizing a content playback device comprising:
providing the content playback device, wherein the content playback device comprises,
a processor,
an input component for receiving content and for receiving configuration instructions,
an output component for outputting content,
a physical user interface including,
a plurality of player control buttons, and
a plurality of content mapped playback buttons;
an internal content component for providing content from a removable media, and
a data storage component for storing at least loaded content;
electronically connecting an input source with the content playback device;
if the input source includes stored content,
selecting at least a portion of the stored content for storing to the content playback device;
mapping at least one of the plurality of content mapped playback buttons to correspond with the selected portion; and
loading the selected portion of stored content to the content playback device.

10. The method of claim 9, further comprising:
if the input source does not include stored content,
providing a live source for live source content;
mapping at least one of the plurality of content mapped playback buttons to correspond with the live source content;
loading the live source content to the content playback device.

11. The method of claim 9, further comprising:
selecting one of the plurality of content mapped playback buttons; and
playing back loaded content corresponding with the content mapped playback button.

12. The method of claim 11, further comprising:
illuminating the selected one of the plurality of content mapped playback buttons during playback.

13. The method of claim 11, further comprising:
selecting any of the plurality of player control buttons to control playback.

14. The method of claim 13, wherein the plurality of player control buttons are selected from the group consisting of: a stop button, a play button, a pause button, a combination play/pause button, a forward button, a back button, a fast forward button, a fast backward button, a next button, a previous button, a combination forward/next button, a combination forward/fast forward/next button, a combination backward/previous button, a combination backward/fast backward/previous button a record button, a load button, a transfer button, an input source button, a player select button, a volume button, and an arrow button.

15. A system for providing simplified playback of content comprising:
a content playback device, wherein the content playback device comprises,
a processor,
an input component for receiving content and for receiving configuration instructions,
an output component for outputting content,
a physical user interface including,
a plurality of player control buttons, and
a plurality of content mapped playback buttons,
an internal content component for providing content from a removable media, and
a data storage component for storing loaded content;
an external content storage for providing stored content; and
an external user interface coupled with a computing device for remotely configuring the content playback device.

16. The system of claim 15, wherein the computing device is coupled with a network capable of receiving stored content from a network connected storage.
